(19) United States
(12) Patent Application Publication
(10) Pub. No.: US 2022/0404140 A1
(43) Pub. Date: Dec. 22, 2022

(54) APPARATUS FOR TRANSMITTING AND/OR RECEIVING TERAHERTZ RADIATION, AND USE THEREOF

(71) Applicant: HELMUT FISCHER GMBH INSTITUT FÜR ELEKTRONIK UND MESSTECHNIK, Sindelfingen (DE)

(72) Inventor: Rüdiger Mästle, Böblingen (DE)

(21) Appl. No.: 17/775,564

(22) PCT Filed: Dec. 16, 2020
(86) PCT No.: PCT/EP2020/086381

§ 371 Date: May 9, 2022

(30) Foreign Application Priority Data
Dec. 20, 2019 (EP) 10 2019 135 487.0

(51) Int. Cl. G01B 11/06; G02B 27/09; G02B 6/42

(52) U.S. Cl. CPC G01B 11/06; G02B 27/09; G02B 6/4216

(57) ABSTRACT

An apparatus for transmitting and/or receiving terahertz, THz, radiation, comprising at least one terahertz element which is configured to generate and/or detect a THz signal, and at least one field-shaping element which in particular is assigned to the at least one terahertz element, wherein the at least one terahertz element is arranged in the region of a first surface of the field-shaping element.

### CROSS REFERENCE TO RELATED APPLICATIONS

The present application claims priority as a national stage application under 35 U.S.C. § 371 to PCT Application No. PCT/EP2020/086381 filed on Dec. 16, 2020, entitled, “APPARATUS FOR TRANSMITTING AND/OR RECEIVING TERAHERTZ RADIATION, AND USE THEREOF,” which claims priority to DE Application No. 102019135487.0 filed on Dec. 20, 2019, entitled ““APPARATUS FOR TRANSMITTING AND/OR RECEIVING TERAHERTZ RADIATION, AND USE THEREOF,” both of which are incorporated by reference herein.

### FIELD

The disclosure relates in general to the field of a terahertz (THz) radiation apparatus for measuring distances and to use of such an apparatus.

### SUMMARY

Embodiments relate to an apparatus for transmitting and/or receiving terahertz, THz, radiation, comprising at least one terahertz element configured to generate and/or detect a THz signal, and at least one field-shaping element which in particular is assigned to the at least one terahertz element, wherein the at least one terahertz element is arranged in the region of a first surface of the field-shaping element.

In further embodiments, it is provided that the at least one terahertz element is arranged relative to the first surface of the field-shaping element such that, in particular at least regionally, an evanescent coupling exists between the at least one terahertz element and the field-shaping element. In this way, for example, THz radiation generated by the at least one terahertz element can be efficiently coupled into the field-shaping element and/or THz radiation to be received can be efficiently coupled from the field-shaping element into the THz element. In particular, according to further embodiments, the evanescent coupling can reduce or avoid reflection of the terahertz radiation that may occur in the intermediate region between the THz element and the field-shaping element, which increases the efficiency of the coupling of the THz radiation between the components.

In further embodiments, it is provided that the at least one terahertz element is arranged relative to the first surface of the field-shaping element such that, in particular at least regionally, a frustrated total reflection can occur and/or does occur, in particular between the at least one terahertz element and the field-shaping element.

In further embodiments, it is provided that the field-shaping element comprises at least one lens and/or is formed as a lens.

In further embodiments, it is provided that the at least one lens is formed as a hemispherical lens or as a hyperhemispherical lens or as an aspherical lens.

In further embodiments, it is provided that the field-shaping element has a low dispersion with less than 5% change in the refractive index and/or a low absorption with less than 2% for the terahertz radiation, particularly in the range between 1 THz and 10 THz.

In further embodiments, it is provided that the field-shaping element at least partially comprises at least one of the following materials or is formed from at least one of the following materials: a) silicon, b) polymeric material, in particular PE and/or HDPE and/or PP and/or PTFE and/or polymethylpentene, PMP, c) polymeric material, in particular PE and/or HDPE and/or PP and/or PTFE and/or PMP, with at least one additive material, in particular a refractive index-increasing additive material, for example titanium dioxide, TiO2, and/or aluminum dioxide, Al2O3.

In further embodiments, it is provided that the field-shaping element has, in the region of at least one surface, in particular in the region of and/or on a second surface opposite the first surface, a surface modification with a reflection-reducing effect, preferably an antireflection coating, wherein the reflection-reducing effect, in particular the antireflection coating, is optimized for a frequency range between 1 THz and 10 THz, in particular between 1 THz and 10 THz, further in particular between 4.5 THz and 6.5 THz.

In further embodiments, it is provided that, in particular at least regionally, a bonding layer, in particular an adhesive layer, is arranged between the at least one terahertz element and the first surface of the field-shaping element.

In further embodiments, it is provided that a layer thickness of the bonding layer is less than 50 micrometers, μm, in particular less than or equal to 10 μm, in particular less than or equal to 7 μm, further in particular less than or equal to 4.0 μm, further in particular less than or equal to 1.0 μm.

In further embodiments, it is provided that the layer thickness of the bonding layer is smaller than a quarter of a wavelength of the THz signal in the bonding layer, in particular smaller than a quarter of a wavelength of a maximum frequency of the THz signal in the bonding layer.

In further embodiments, it is provided that the bonding layer at least partially comprises at least one of the following materials or is formed from at least one of the following materials: a) polymeric material, in particular PE and/or HDPE and/or PP and/or PTFE and/or PMP, b) polymeric material, in particular PE and/or HDPE and/or PP and/or PTFE and/or PMP, with at least one additive material, in particular a refractive index-increasing additive material, for example titanium dioxide, TiO2, and/or aluminum dioxide, Al2O3, c) adhesive material, in particular adhesive, in particular with at least one additive material, in particular a refractive index-increasing additive material, for example titanium dioxide, TiO2, and/or aluminum dioxide, Al2O3.

In further embodiments, it is provided that the bonding layer has a refractive index n greater than or equal to 1.6, in particular greater than 2.0, in particular greater than 3.0.

In further embodiments, it is provided that the at least one terahertz element is connected, in particular at least regionally, to the field-shaping element in a force-fit and/or form-fit and/or material-fit manner, wherein in particular a clamp connection and/or solder connection is provided.

In further embodiments, it is provided that, in particular at least regionally, between the at least one terahertz element and the first surface of the field-shaping element a gap, in particular an air gap, further in particular a technical zero gap, is provided.

In further embodiments, it is provided that the at least one terahertz element rests on the first surface of the field-shaping element with a first surface, in particular at least regionally in an areal manner.

In further embodiments, it is provided that the at least one terahertz element comprises a first substrate and an electrode arrangement, wherein in particular the electrode arrangement is arranged on a first surface of the first substrate. According to further embodiments, the electrode arrangement can be used, for example, to provide an electrical DC voltage that can be used to generate THz pulses, or to derive an electrical current that is generated when terahertz signals are received, for example for signal amplification and/or signal evaluation.

In further embodiments, it is provided that the first surface of the first substrate is facing the first surface of the field-shaping element, wherein in particular the first surface of the first substrate abuts the first surface of the field-shaping element, in particular at least regionally in an areal manner.

In further embodiments, it is provided that the at least one terahertz element and/or the first substrate comprises a photoconductive material, wherein in particular the photoconductive material comprises at least one of the following materials: a) indium phosphide, InP, b) gallium arsenide, GaAs, c) indium gallium arsenide, InGaAs, wherein in particular the photoconductive material is doped, in particular with iron.

In further embodiments, it is provided that the at least one terahertz element comprises one or more further substrates, and wherein the first substrate is arranged, in particular at least regionally, on the one further substrate or the plurality of further substrates, wherein in particular the first substrate is arranged with a second surface opposite its first surface, in particular at least regionally, on the at least one further substrate, in particular on a first surface of the at least one further substrate.

In further embodiments, it is provided that the first substrate and/or the at least one further substrate is at least partially transparent to optical radiation in a wavelength range between 1450 nanometers, nm, to 1650 nm and/or in a wavelength range between 850 nm and 1650 nm.

In further embodiments, the first substrate and/or the at least one further substrate has a comparatively high transmission for the optical radiation, in particular in the aforementioned wavelength range. Further, the comparatively high transmission can preferably be achieved by a choice of material (e.g. silicon, Si, silicon dioxide, SiO2) and/or a reflection-reducing coating on at least one surface of the (at least one further) substrate, in particular on a surface or side of the (at least one further) substrate onto which the optical radiation can be irradiated.

In further embodiments, it is provided that a) a second surface opposite its first surface or the second surface of the first substrate and/or b) a second surface of the at least one further substrate opposite its first surface can be exposed to a first optical radiation, in particular laser radiation, in particular laser radiation in a wavelength range between 1450 nm and 1650 nm.

In further embodiments, it is provided that an irradiation device is provided for at least temporarily exposing at least one region of the terahertz element to a first optical radiation or the first optical radiation, wherein the irradiation device comprises at least one optical fiber or is formed as an optical fiber.

In further embodiments, it is provided that the irradiation device, in particular the optical fiber, is arranged and/or aligned with respect to the first substrate and/or a or the at least one further substrate such that an exit surface for coupling out the first optical radiation is opposite to a) a second surface opposite the first surface or the second surface of the first substrate, and/or b) a second surface opposite the first surface of the at least one further substrate, in particular in such a way that aa) the second surface of the first substrate and/or bb) the second surface of the at least one further substrate can be exposed to the first optical radiation.

In further embodiments, it is provided that the optical fiber is a monomode fiber, in particular a polarization-maintaining optical fiber.

In further embodiments, it is provided that the apparatus comprises a plurality of terahertz elements, wherein a) at least two, preferably all, of the plurality of terahertz elements are arranged in the region of the first surface of the field-shaping element, and/or b) the at least one field-shaping element is assigned to at least two of the plurality of terahertz elements.

In further embodiments, it is provided that at least two, preferably all, of the plurality of terahertz elements are arranged side by side, wherein in particular respective electrode arrangements of the at least two, preferably all, terahertz elements lie in a same first virtual plane, wherein in particular the first virtual plane is parallel to the first surface of the field-shaping element.

In further embodiments, it is provided that at least two, preferably all, of the plurality of terahertz elements are arranged one behind the other, wherein in particular respective electrode arrangements of the at least two, preferably all, terahertz elements lie in mutually different respective virtual planes, wherein in particular at least two of the virtual planes are parallel to the first surface of the field-shaping element.

In further embodiments, it is provided that at least two of the plurality of terahertz elements at least partially overlap spatially.

In further embodiments, it is provided that a common electrode structure is assigned to the plurality of terahertz elements.

In further embodiments, it is provided that the apparatus is adapted to output the terahertz radiation in the form of a divergent beam, which can be realized in particular with one or more mirrors, in particular parabolic mirrors, in particular off-axis parabolic mirrors. In further embodiments, it is provided that the apparatus is adapted to output the terahertz radiation in the form of a collimated beam.

In further embodiments, it is provided that the apparatus comprises at least one manipulation device for manipulating a beam path of the terahertz radiation, wherein in particular the at least one manipulation device comprises a reflection device for the terahertz radiation, in particular at least one mirror.

In further embodiments, it is provided that the reflection device comprises at least a first mirror and a second mirror, and wherein the apparatus is adapted to a) selectively position the first mirror or the second mirror in the beam path of the terahertz radiation, and/or b) at least temporarily position the first mirror and at least temporarily position the second mirror in the beam path of the terahertz radiation.

In further embodiments, it is provided that the first mirror has a first focal length and the second mirror has a second focal length different from the first focal length.

In further embodiments, it is provided that the second mirror can be driven and/or changed and/or replaced without tools and/or by motor, wherein it can be replaced e.g. by a further, e.g. third mirror, wherein preferably a beam direction of the THz radiation after the second and third mirror is preferably collinear. In further preferred embodiments, this can be realized, e.g., by a plurality of stops, in particular, e.g., for axial and lateral positioning of the respective mirror.

In further embodiments, it is provided that the apparatus comprises at least one of the following elements: a) click module, b) magnetic holder, c) turret, in particular for at least temporarily holding and/or positioning of at least the first and/or second mirror.

In further embodiments, it is provided that the apparatus is adapted to apply to the at least one terahertz element, at least temporarily, a first pulsed laser radiation having a first pulse frequency and a second pulsed laser radiation having a second pulse frequency, wherein in particular the second pulse frequency is different from the first pulse frequency.

In further embodiments, it is provided that the apparatus is adapted to provide a protective gas flow comprising a protective gas in at least one region of a beam path of the THz radiation, in particular of the THz signal, wherein in particular the protective gas comprises at least one of the following elements or is formed from at least one of the following elements: (a) dry air, (b) dry gas, (c) dry gas mixture, (d) at least one gas having no absorption line in a frequency range of the THz radiation, wherein in particular the protective gas has a dew point temperature of −20° C. (degree Celsius) or less, preferably −30° C. or less, further preferably −40° C. or less, wherein in particular the protective gas causes an attenuation of the THz radiation along the beam path of 0.1 dB or less, preferably for each frequency of the THz radiation.

In further embodiments, it is provided that the apparatus further comprises: a) at least one supply device for at least temporarily providing the protective gas flow, and/or b) at least one pressure manipulation member for manipulating a pressure of the protective gas.

In further embodiments, it is provided that the apparatus further comprises: at least one nozzle, wherein in particular the nozzle is adapted and/or arranged to direct the protective gas flow or at least a portion of the protective gas flow into the at least one region of the beam path of the THz radiation, wherein in particular the at least one nozzle is a free-jet nozzle.

In further embodiments, it is provided that the apparatus comprises at least one optical sensor device, e.g., an optical distance sensor, e.g., an optical triangulation sensor, and/or e.g. at least one three-dimensional imaging device (e.g., a laser scanner), capable of detecting or determining at least one of the following elements: a) distance of a measurement object relative to the apparatus, b) inclination of the apparatus relative to the measurement object, c) a shape, in particular surface shape, of the measurement object.

Further embodiments relate to a measuring device, in particular for determining at least one physical parameter of an object, comprising at least one apparatus according to the embodiments.

In further embodiments, it is provided that the measuring device is adapted to determine a layer thickness of at least one layer of a measurement object, in particular by using a model-based method in which a model of the at least one layer is used.

Further embodiments relate to a use of the apparatus according to the embodiments and/or the measuring device according to the embodiments for at least one of the following elements: a) transmitting and/or receiving terahertz, THz, radiation, in particular THz pulses, b) determining, in particular model-based determining, a layer thickness of one or more layers, in particular paint layers on a component, in particular on a body part, c) at least temporarily positioning the first mirror and at least temporarily positioning the second mirror in the beam path of the terahertz radiation, d) at least temporarily and/or at least regionally providing an evanescent coupling between the at least one terahertz element and the field-shaping element, e) at least temporarily applying to at least one space region a protective gas, in particular a protective gas flow, wherein the at least temporarily applying to the at least one space region the protective gas, in particular a protective gas flow, is synchronized with the transmitting and/or receiving of the THz radiation, f) transmitting terahertz, THz, radiation, in particular THz pulses, into a space region or into the space region to which a protective gas or the protective gas is applied.

Further characteristics, possible applications, and advantages of one or more embodiments can be derived from the following description, which are shown in the drawing figures. In this context, the features described or illustrated include the subject-matter of the embodiments, either individually or in any combination, irrespective of their relation in the claims or the references between the claims, and irrespective of their formulation or representation in the description or in the drawings.

### BRIEF DESCRIPTION OF THE DRAWINGS

FIG. 1 schematically shows a side view of an apparatus according to embodiments.

FIG. 2 schematically shows a side view of an apparatus according to further embodiments.

FIG. 3 schematically shows a side view of an apparatus according to further embodiments.

FIG. 4 schematically shows a side view of an apparatus according to further embodiments.

FIG. 5 schematically shows a side view of a terahertz element according to further embodiments.

FIG. 6 schematically shows a side view of a terahertz element according to further embodiments.

FIG. 7 schematically shows a side view of an apparatus according to further embodiments.

FIG. 8 schematically shows a side view of an apparatus according to further embodiments.

FIG. 9 schematically shows a side view of an apparatus according to further embodiments.

FIG. 10 schematically shows a top view of terahertz elements according to further embodiments.

FIG. 11 schematically shows a side view of an apparatus according to further embodiments.

FIG. 12A schematically shows a side view of an apparatus in partial cross-section according to further embodiments.

FIG. 12B schematically shows a side view of an apparatus in partial cross-section according to further embodiments.

FIG. 13 schematically shows a side view of an apparatus according to further embodiments.

FIG. 14 schematically shows a side view of an apparatus according to further embodiments.

FIG. 15 schematically shows exemplary uses of an apparatus according to further embodiments.

FIG. 16 schematically shows a side view of a measurement object according to further embodiments.

FIG. 17 schematically shows a measuring device according to further embodiments.

### DETAILED DESCRIPTION

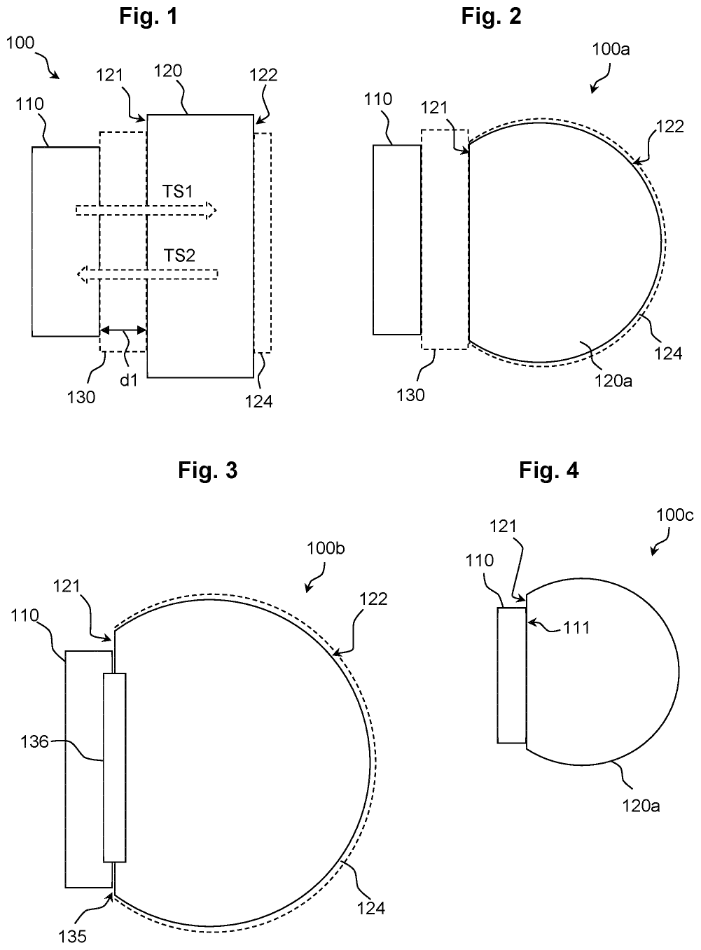

Embodiments relate to an apparatus 100 for transmitting and/or receiving terahertz, THz, radiation TS1, TS2. FIG. 1 schematically shows an exemplary side view of such an apparatus 100 according to one or more embodiments described herein. The apparatus 100 comprises at least one terahertz element 110, which is adapted to generate in particular a THz signal TS1 to be transmitted and/or to detect in particular a THz signal TS2 to be received, and at least one field-shaping element 120, which in particular is assigned to the at least one terahertz element 110, wherein the at least one terahertz element 110 is arranged in the region of a first surface 121 of field-shaping element 120.

In further embodiments, it is provided that the at least one terahertz element 110 is arranged relative to a first surface 121 of field-shaping element 120 such that, in particular at least regionally, an evanescent coupling exists between the at least one terahertz element 110 and field-shaping element 120. In this way, for example, THz radiation TS1 generated by the at least one terahertz element 110 can be efficiently coupled into field-shaping element 120 and/or THz radiation TS2 to be received can be efficiently coupled from field-shaping element 120 into THz element 110. In particular, according to embodiments, the evanescent coupling may reduce or avoid reflection that may occur in the intermediate region between THz element 110 and field-shaping element 120, which increases the efficiency of the coupling of the THz radiation TS1, TS2 between the components 110, 120. In particular, according to embodiments, undesired attenuation and/or pulse broadening of the THz radiation can thus also be advantageously reduced.

In further embodiments, it is provided that the at least one terahertz element 110 is arranged relative to a first surface 121 of field-shaping element 120 such that, in particular at least regionally, a frustrated total reflection can occur and/or does occur, in particular between the at least one terahertz element 110 and field-shaping element 120.

In further embodiments, it is provided that field-shaping element 120 comprises at least one lens 120 and/or is formed as a lens 120.

In further embodiments, the at least one lens 120 is provided as a hemispherical lens or a hyperhemispherical lens 120a (cf. apparatus 100a of FIG. 2) or as an aspherical lens.

In further embodiments, field-shaping element 120 (FIG. 1) may also include at least one THz radiation reflecting apparatus (not shown), such as a reflector or mirror. In further embodiments, field-shaping element 120 may also be formed as a metamaterial-based element, and/or a gradient index lens.

In further embodiments, it is provided that field-shaping element 120, 120a comprises at least partially at least one of the following materials or is formed from at least one of the following materials: a) silicon; b) polymeric material, in particular PE and/or HDPE and/or PP and/or PTFE and/or PMP; c) polymeric material, in particular PE and/or HDPE and/or PP and/or PTFE and/or PMP, with at least one additive material, in particular a refractive index-increasing additive material, for example titanium dioxide, TiO2, and/or aluminum dioxide, Al2O3.

In further embodiments, it is provided that field-shaping element 120, 120a has, in the region of at least one surface 121, 122, in particular in the region of and/or on a second surface 122 opposite the first surface 121, a surface modification 124 with a reflection-reducing effect (with respect to at least one wavelength of the THz radiation TS1, TS2). The surface modification 124 may-comprise an antireflection coating, wherein in particular the reflection-reducing effect, in particular antireflection coating, is optimized for a frequency range between 3 THz and 10 THz, in particular between 4.5 THz and 6.5 THz.

In further embodiments (FIG. 1), it is provided that, in particular at least regionally, a bonding layer 130, which may in particular comprise an adhesive layer, is arranged between the at least one terahertz element 110 and first surface 121 of the field-shaping element 120.

In further embodiments, it is provided that a layer thickness dl (FIG. 1) of bonding layer 130 is less than 50 micrometers, μm, in particular less than or equal to 10 μm, in particular less than or equal to 7 μm, further in particular less than or equal to 4.0 μm, further in particular less than or equal to 1.0 μm.

In further embodiments, it is provided that the layer thickness dl of bonding layer 130 is smaller than a quarter of a wavelength of the THz signal TS1, TS2 in bonding layer 130, in particular smaller than a quarter of a wavelength of a maximum frequency of the THz signal TS1, TS2 in bonding layer 130.

In further embodiments, it is provided that bonding layer 130 at least partially comprises at least one of the following materials or is formed from at least one of the following materials: a) polymeric material, in particular PE and/or HDPE and/or PP and/or PTFE and/or, PMP; b) polymeric material, in particular PE and/or HDPE and/or PP and/or PTFE and/or, PMP, with at least one additive material, in particular a refractive index-increasing additive material, for example titanium dioxide, TiO2, and/or aluminum dioxide, Al2O3; c) adhesive material, in particular adhesive, in particular with at least one additive material, in particular a refractive index-increasing additive material, for example titanium dioxide, TiO2, and/or aluminum dioxide, Al2O3.

In further embodiments, it is provided that bonding layer 130 has a refractive index n greater than or equal to 1.6, in particular greater than 2.0, in particular greater than 3.0.

In further embodiments, cf. e.g. apparatus 100b according to FIG. 3, it is provided that the at least one terahertz element 110 is connected, in particular at least regionally, to field-shaping element 120, 120a in a force-fit and/or form-fit and/or material-fit manner, wherein in particular a clamp connection and/or solder connection 136, e.g. glass solder, is provided.

In further embodiments, cf. FIG. 3, it is provided that, in particular at least regionally, between the at least one terahertz element 110 and first surface 121 of field-shaping element 121 a gap 135, in particular an air gap, further in particular a technical zero gap, is provided.

In further embodiments, cf. apparatus 100c of FIG. 4, it is provided that the at least one terahertz element 110 rests on first surface 121 of field-shaping element 120 with a first surface 111, in particular at least regionally in an areal manner, preferably over the entire area of the first surface 111.

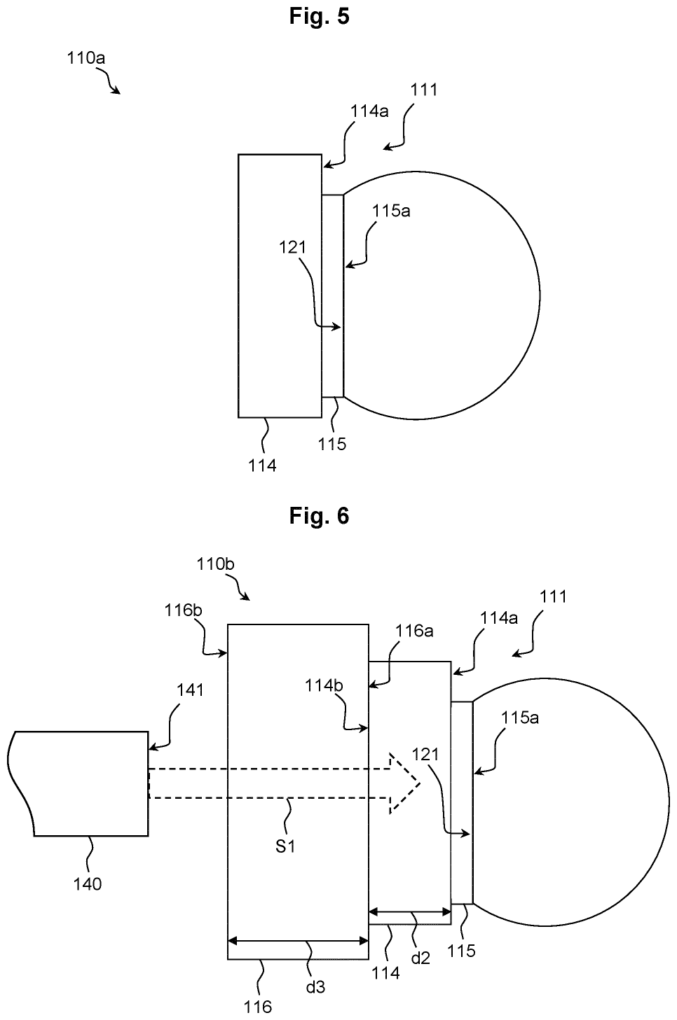

In further embodiments, cf. FIG. 5, it is provided that the at least one terahertz element 110a comprises a first substrate 114 and an electrode arrangement 115, wherein in particular electrode arrangement 115 is arranged on a first surface 114a of first substrate 114.

In further embodiments, it is provided that first surface 114a of first substrate 114 is facing first surface 121 of field-shaping element 120, wherein in particular first surface 114a of first substrate 114 abuts first surface 121 of field-shaping element 120, in particular at least regionally in an areal manner, preferably over the entire area. Further, electrode arrangement 115 is located between first substrate 114 and first surface 121 of field-shaping element 120, 120a, in particular such that a surface 115a of electrode arrangement 115 at least regionally contacts first surface 121 of field-shaping element 120, 120a.

In further embodiments, it is provided that the at least one terahertz element 110, 110a and/or first substrate 114 (FIG. 5) comprises a photoconductive material, wherein in particular the photoconductive material comprises at least one of the following materials: a) indium phosphide, InP; b) gallium arsenide, GaAs; c) indium gallium arsenide, InGaAs, wherein in particular the photoconductive material is doped, in particular with iron.

In further embodiments, cf. FIG. 6, it is provided that the at least one terahertz element 110b comprises at least one further substrate 116, wherein first substrate 114 is arranged, in particular at least regionally, on the at least one further substrate 116, wherein in particular first substrate 114 is arranged with a second surface 114b opposite its first surface 114a, in particular at least regionally, on the at least one further substrate 116, in particular on a first surface 116a of the at least one further substrate 116.

In further embodiments, it is provided that first substrate 114 and/or the at least one further substrate 116 is at least partially transparent (in particular transmission greater than about 95 percent) for optical radiation in a wavelength range between 1450 nanometers, nm, to 1650 nm and/or in a wavelength range between 850 nm and 1650 nm. This allows the optical radiation S1 to be efficiently introduced through the first and/or the at least one further substrate 114, 116, e.g., into the region of electrode arrangement 115, in which, according to further embodiments, the generation and/or detection of the THz radiation can take place.

In further embodiments, it is provided that a) a second surface 114b opposite a first surface 114a or second surface 114b of first substrate 114 and/or b) a second surface 116b opposite a first surface 116a of the at least one further substrate 116 can be exposed to first optical radiation S1, in particular to laser radiation S1, preferably pulsed laser radiation S1, in particular to laser radiation S1 in a wavelength range between 1450 nm and 1650 nm.

In further embodiments, it is provided that an irradiation device 140 is provided for at least temporarily exposing at least one region of terahertz element 110, 110a, 110b to a first optical radiation S1 or the first optical radiation S1, wherein irradiation device 140 comprises at least one optical fiber 140 or is formed as an optical fiber 140.

In further embodiments, irradiation device 140 may also comprise a laser source (not shown) for generating the first optical radiation S1, wherein according to further embodiments the laser source may be arranged in the region of THz element 110b, e.g. in FIG. 6 to the left of THz element 110b. In this regard, according to further embodiments, in some cases, for example, the provision of an optical fiber 140 may also be omitted, i.e., the first optical radiation S1 can be directly irradiated from the laser source onto THz element 110b. In further embodiments, the laser source may also be provided and/or arranged remotely from THz element 110b, and the first optical radiation S1 may be guided from the laser source to THz element 110b by means of optical fiber 140, for example, and irradiated onto THz element 110b through exit aperture 141.

In further embodiments, it is provided that irradiation device 140, in particular optical fiber 140, is arranged and/or aligned with respect to first substrate 114 and/or a or the at least one further substrate 116 such that its exit surface 141 for coupling out the first optical radiation S1 is opposite to a) a second surface 114b opposite first surface 114a or second surface 114b of first substrate 114 and/or b) a second surface 116b opposite first surface 116a of the at least one further substrate 116, in particular in such a way that aa) second surface 114b of first substrate 114 and/or bb) second surface 116b of the at least one further substrate 116 can be exposed to the first optical radiation S1.

In further embodiments, it is provided that optical fiber 140 is a monomode fiber, in particular a polarization-maintaining optical fiber 140.

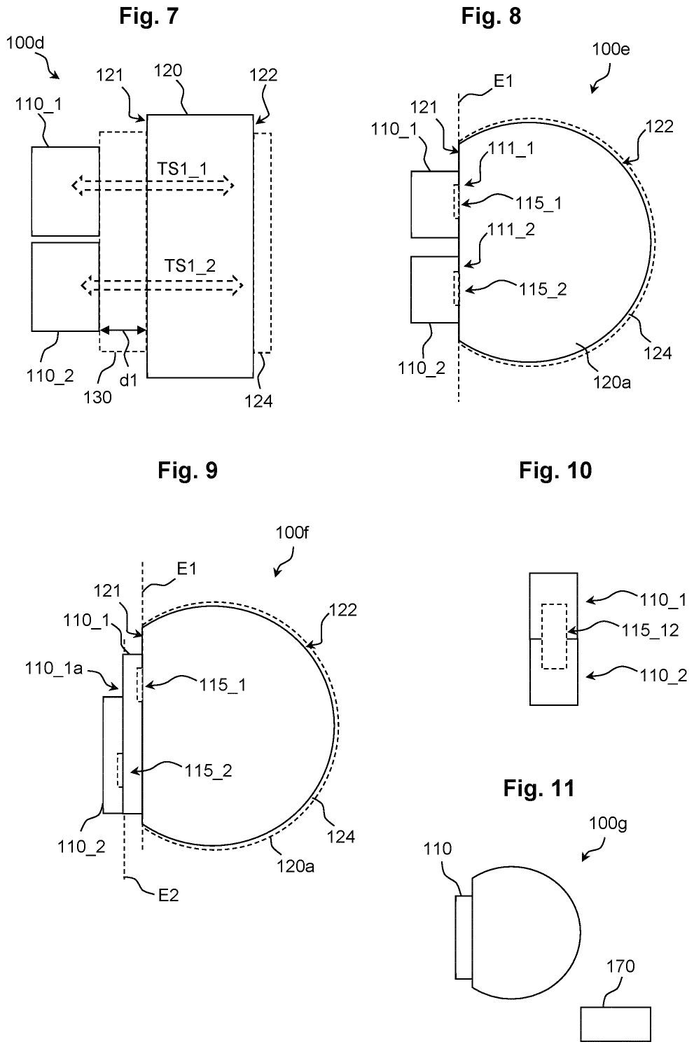

In further embodiments, cf. FIG. 7, it is provided that apparatus 100d comprises a plurality of terahertz elements 110_1, 110_2, wherein a) at least two, preferably all, of the plurality of terahertz elements 110_1, 110_2 are arranged in the region of first surface 121 of field-shaping element 120, and/or b) the at least one field-shaping element 120 is assigned to at least two of the plurality of terahertz elements 110_1, 110_2. Thus, in further embodiments, a field-shaping element 120 which is “common” with respect to or used jointly by the plurality of terahertz elements 110_1, 110_2 may be used to shape the THz radiation TS1_1, TS1_2 associated with the respective terahertz elements 110_1, 110_2.

While FIG. 7 shows two terahertz elements 110_1, 110_2 as an example, according to further embodiments it is also possible to provide three or more terahertz elements, in particular to assign them to field-shaping element 120. As can be derived from FIG. 7, in the present case, both terahertz elements 110_1, 110_2 are arranged on first surface 121 of field-shaping element 120 by means of an adhesive layer 130. In further embodiments, at least some or even all of the plurality of terahertz elements 110_1, 110_2 may be arranged, alternatively to adhesive layer 130, by means of a solder joint 136 (FIG. 3) and/or a clamp joint in the region of or on first surface 121 of field-shaping element 120. Combinations of adhesive layer 130 and/or solder connection 136 (FIG. 3) and/or the clamp connection may also be implemented according to further embodiments.

In further embodiments, cf. apparatus 100e of FIG. 8, it is provided that at least two, preferably all, of the plurality of terahertz elements 110_1, 110_2 are arranged side by side, wherein in particular respective electrode arrangements 115_1, 115_2 of the at least two, preferably all, terahertz elements 110_1, 110_2 lie in a same first virtual plane E1, wherein in particular the first virtual plane E1 is parallel to first surface 121 of field-shaping element 120. In further embodiments, the first virtual plane E1 may also correspond, for example, to first surface 121 of field-shaping element 120.

In further embodiments, it is provided that both terahertz elements 110_1, 110_2 rest with their respective first surface 111_1, 111_2, in particular at least regionally in an areal manner, on first surface 121 of field-shaping element 120.

In further preferred embodiments, cf. apparatus 100f of FIG. 9, it is provided that at least two, preferably all, of the plurality of terahertz elements 110_1, 110_2 are arranged one behind the other (in particular with respect to the (main) propagation direction of the THz radiation, i.e. along a virtual horizontal line shown in FIG. 9, for example), wherein in particular respective electrode arrangements 115_1, 115_2 of the at least two, preferably all, terahertz elements 110_1, 110_2 lie in mutually different respective virtual planes E1, E2, wherein in particular at least two of the virtual planes E1, E2 are parallel to first surface 121 of field-shaping element 120a. In the present example, second terahertz element 110_2 is arranged on a surface 110_1a of first terahertz element 110_1.

In further embodiments, it is provided that at least two of the plurality of terahertz elements at least partially overlap spatially (not shown).

In further embodiments, cf. FIG. 10, it is provided that a common electrode structure 115_12 is assigned to the plurality of terahertz elements 110_1, 110_2. According to further preferred embodiments, the arrangement of the configuration 110_1, 110_2, 115_12 illustrated in FIG. 10 on field-shaping element 120, 120a may be, for example, analogous to the configuration according to FIG. 1 or FIG. 3 or FIG. 7 or FIG. 8.

In further embodiments, it is provided that apparatus 100 (FIG. 1) is configured to output the terahertz radiation TS1 in the form of a collimated beam (i.e. parallel beam). Thereby, a distance dependency of measurements based on the terahertz radiation TS1 with respect to a measurement object is reduced or eliminated.

In further embodiments, it is provided that apparatus 100 (FIG. 1) is configured to output the terahertz radiation TS1 in the form of a divergent beam, wherein, according to further embodiments, (further) beam shaping is performed with one or more further optical elements, e.g., to obtain a collimated beam. Thereby, a distance dependence of measurements based on the terahertz radiation TS1 with respect to a measurement object is reduced or eliminated.

In further embodiments, cf. apparatus 100g of FIG. 11, it is provided that apparatus 100g comprises at least one optical sensor device 170, e.g. an optical distance sensor, in particular triangulation sensor and/or e.g. at least one three-dimensional imaging device (such as a laser scanner), which is capable of detecting or determining at least one of the following elements: a) distance of a measurement object relative to apparatus 100g; b) inclination of apparatus 100g relative to the measurement object; c) a shape, in particular surface shape, of the measurement object.

Using the optical distance sensor, in particular the triangulation sensor, for example, a distance of apparatus 100g or a distance of one of its components 110 from a measurement object to be applied in particular with a THz signal TS1 (FIG. 1) can be advantageously determined based on an optical measurement principle. Thus, a precision of THz radiation-based measurements by means of apparatus 100g can be further increased.

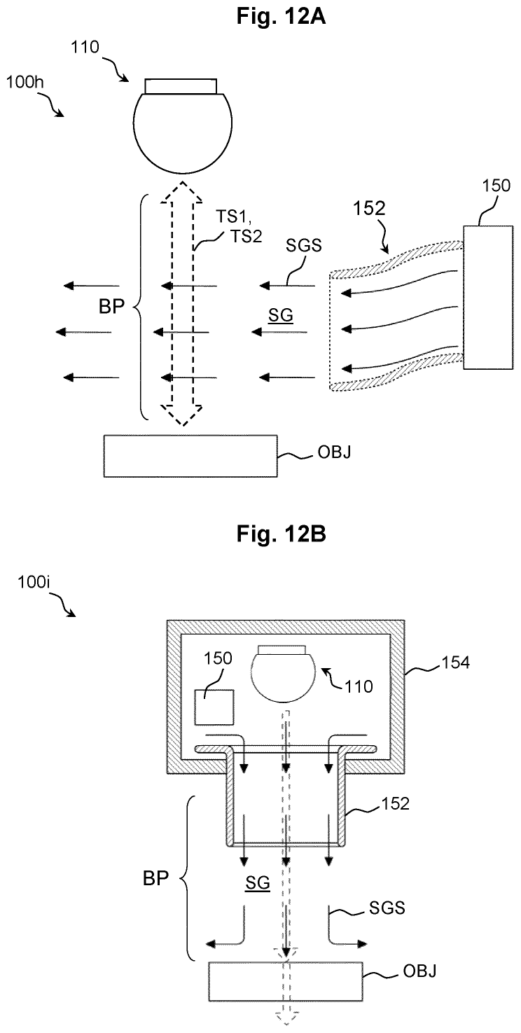

In further embodiments, cf. apparatus 100h of FIG. 12A, it is provided that apparatus 100h is adapted to provide a protective gas flow SGS comprising a protective gas SG in at least one region of a beam path BP of the THz radiation TS1, TS2, in particular of the THz signal, wherein in particular the protective gas SG comprises at least one of the following elements or is formed from at least one of the following elements: (a) dry air; (b) dry gas; (c) dry gas mixture; (d) at least one gas having no absorption line in a frequency range of the THz radiation TS1, TS2, wherein in particular the protective gas SG has a dew point temperature of −20° C. or less, preferably −30° C. or less, further preferably −40° C. or less, wherein in particular the protective gas SG causes an attenuation of the THz radiation TS1, TS2 along the beam path BP of 0.1 dB or less, preferably for each frequency of the THz radiation TS1, TS2.

In further embodiments, it is provided that apparatus 100h further comprises: a) at least one supply device 150 for at least temporarily providing the protective gas flow SGS, and/or b) at least one pressure manipulation member (not shown) for manipulating a pressure of the protective gas SG.

In further embodiments, it is provided that apparatus 100h further comprises: at least one nozzle 152, wherein in particular nozzle 152 is adapted and/or arranged to direct the protective gas flow SGS or at least a part of the protective gas flow SGS into the at least one region of the beam path BP of the THz radiation TS1, TS2, wherein in particular the at least one nozzle 152 is a free-jet nozzle. As a result, a beam path BP of the terahertz radiation TS1, TS2, in particular almost the entire beam path BP of the terahertz radiation TS1, TS2 between terahertz element 110 and a measurement object OBJ, can be exposed to the protective gas SG in a defined manner, which enables particularly precise measurements by means of the terahertz radiation TS1, TS2. For example, according to further embodiments, this also enables the generation of a substantially laminar protective gas flow SGS along the beam path BP. In particular, according to further embodiments, the direction of the protective gas flow SGS can also be, for example, at least approximately parallel to the propagation direction of the terahertz radiation TS1, TS2.

FIG. 12B shows an example of an apparatus 100i according to further embodiments, in which a housing 154 is provided. In particular, the at least one terahertz element 110, as well as at least a part of supply device 150, may be arranged inside housing 154. The protective gas SG enables a particularly precise measurement by means of the terahertz radiation TS1, TS2, because the medium SG in the region of the beam path BP thereby has a defined, in particular low, absorption of the terahertz radiation TS1, TS2, in particular compared to regular ambient air. Further, the apparatus 100i can be adapted to generate a laminar protective gas flow SGS in the region of the beam path BP, whereby the precision of measurements based on the terahertz radiation TS1, TS2 can be further increased.

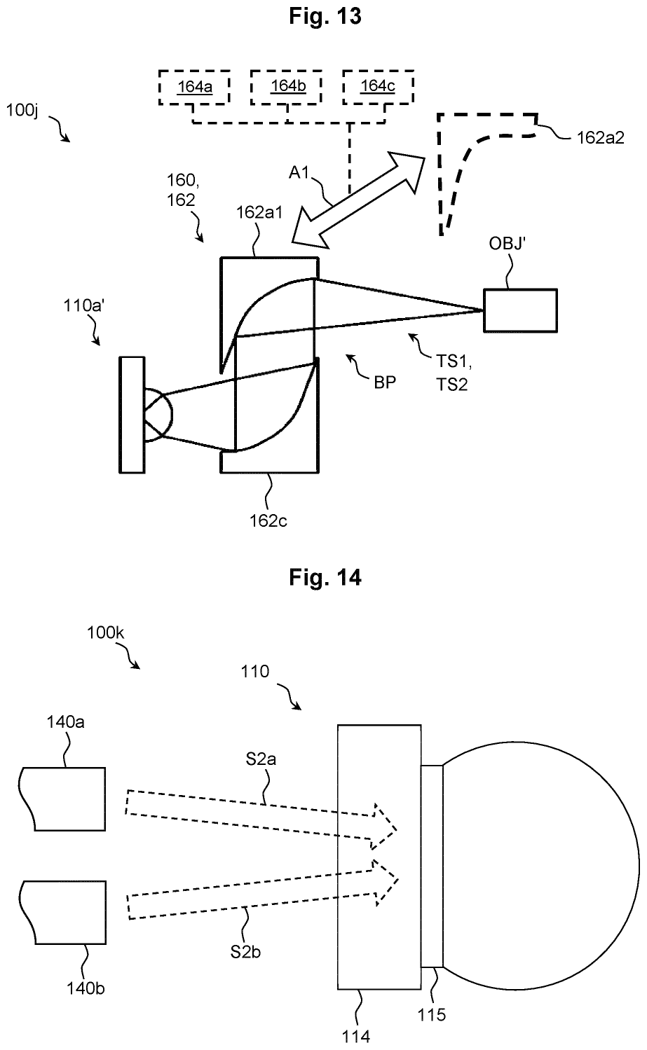

In further embodiments, cf. apparatus 100j in FIG. 13, it is provided that apparatus 100j comprises at least one manipulation device 160 for manipulating a beam path BP of the terahertz radiation TS1, TS2, wherein in particular the at least one manipulation device 160 comprises a reflection device 162 for the terahertz radiation TS1, TS2, in particular at least one mirror 162a1, 162a2. As a result, the terahertz radiation TS1, TS2 can be efficiently guided from a terahertz element 110a′ (which may, for example, have the configuration 110a according to FIG. 5) to a measurement object OBJ′ to be examined and/or vice versa.

In further embodiments, it is provided that reflection device 160 comprises at least a first mirror 162a1 and a second mirror 162a2 (and in the present example also an optional third mirror 162c), wherein apparatus 100j is adapted to: a) selectively position first mirror 162a1 or second mirror 162a2 in the beam path BP of the terahertz radiation TS1, TS2; and/or b) at least temporarily position first mirror 162a1 and at least temporarily position second mirror 162a2 in the beam path BP of the terahertz radiation TS1, TS2. This is schematically indicated by block arrow Al.

In further embodiments, it is provided that first mirror 162a1 has a first focal length, wherein second mirror 162a2 has a second focal length different from the first focal length. As a result, the imaging characteristics of the beam path BP for the terahertz radiation TS1, TS2 can be changed efficiently, and may be changed dynamically (during operation of apparatus 100j), quasi by “switching” Al between mirrors 162a1, 162a2.

In further embodiments, it is provided that second mirror 162a2 can be driven and/or changed and/or replaced without tools and/or by motor, wherein it can be replaced e.g. by a further, e.g. third mirror, wherein preferably a beam direction of the THz radiation TS1, TS2 downstream of the second and third mirrors is preferably collinear. In further embodiments, this can be realized e.g. by several stops (not shown), in particular e.g. for axial and lateral positioning of the respective mirror.

In further embodiments, it is provided that apparatus 100j comprises at least one of the following elements: a) click module 164a, b) magnetic holder 164b, c) turret 164c, in particular for at least temporarily holding and/or positioning at least first mirror 162a1 and/or second mirror 162a2.

In further embodiments, cf. apparatus 100k of FIG. 14, it is provided that apparatus 100k is adapted to at least temporarily apply to the at least one terahertz element 110 a first pulsed laser radiation S2a having a first pulse frequency and a second pulsed laser radiation S2b having a second pulse frequency, wherein in particular the second pulse frequency is at least temporarily different from the first pulse frequency. Preferably, the pulsed laser radiation S2a, S2b can be provided by means of at least one optical fiber (exemplarily, two fibers 140a, 140b are illustrated herein) and be radiated, for example, onto terahertz element 110. Optionally, for generating the pulsed laser radiation S2a, S2b, respective laser sources (not shown) may be provided, which according to further preferred embodiments may be arranged locally with respect to THz element 110 or remote therefrom. In this respect, according to further embodiments, what has been described above with respect to FIG. 6 also applies in a corresponding manner to the configuration 100k according to FIG. 14.

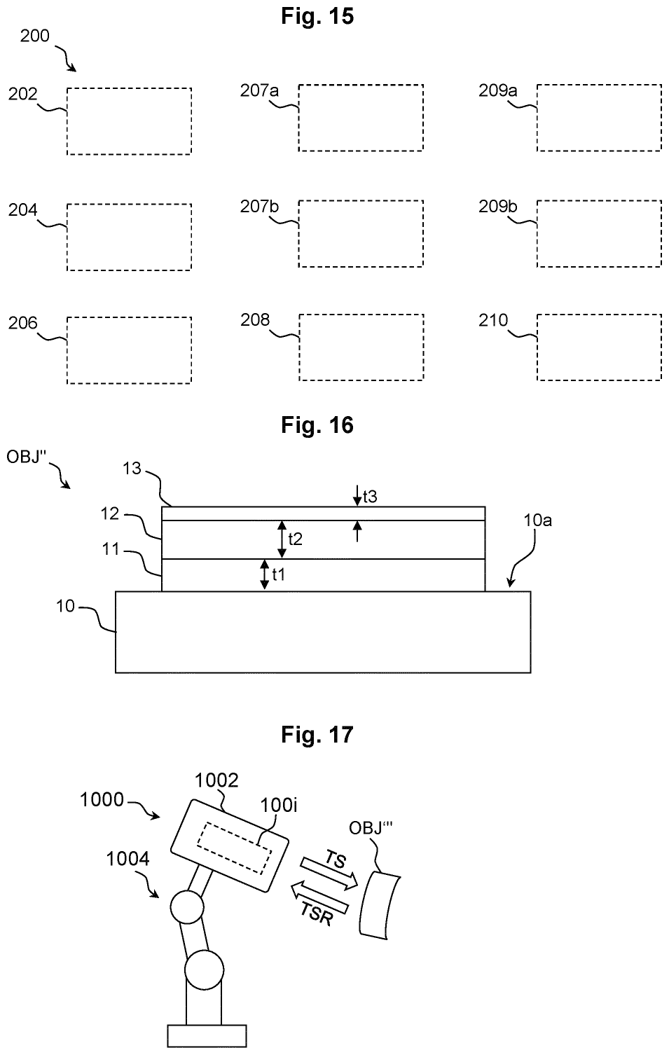

Further embodiments, cf. FIG. 15, relate to a use 200 of the apparatus according to the embodiments for at least one of the following elements: a) transmitting 202 and/or receiving 204 terahertz, THz, radiation TS1, TS2 (FIG. 1), in particular THz pulses, b) determining 206, in particular model-based determining, of a layer thickness of one or more layers, in particular paint layers on a component, in particular on a body part, c) at least temporarily positioning 207a the first mirror 162a1 (FIG. 13) and at least temporarily positioning 207b the second mirror 162a2 in the beam path BP of terahertz radiation TS1, TS2, d) at least temporarily and/or at least regionally providing 208 an evanescent coupling between the at least one terahertz element 110 and field-shaping element 120, e) at least temporarily applying 209a to at least one space region to a protective gas SG (FIGS. 12A, 12B), in particular a protective gas flow SGS, wherein the at least temporarily applying to the at least one space region the protective gas, in particular a protective gas flow, is synchronized with the transmitting and/or receiving of the THz radiation 209b (FIG. 15), f) transmitting 210 of terahertz, THz, radiation TS1, in particular THz pulses, into a space region or into the space region to which a protective gas SG or the protective gas SG or a protective gas flow SGS, respectively, is applied.

FIG. 16 schematically shows a side view of a measurement object OBJ″, which comprises a substrate 10 and a layer arrangement arranged on a first surface 10a of substrate 10 and comprising, for example, three layers 11, 12, 13. The three layers 11, 12, 13 have thicknesses t1, t2, t3 and can represent, for example, paint layers of a body part 10. In further preferred embodiments, at least one apparatus according to the embodiments may be used to apply terahertz radiation TS1 (FIG. 1) to the measurement object OBJ″ according to FIG. 16. The terahertz radiation TS1 is reflected in particular at respective boundary layers between elements 10, 11, 12, 13 or at a surface of uppermost layer 13 in FIG. 16, and can be received, according to further embodiments, as reflected terahertz radiation TS2 by the at least one apparatus (and/or by at least one apparatus of the same type or similar type), in order, for example, to determine the respective layer thicknesses t1, t2, t3 by means of a model-based method, e.g. based on time domain reflectometry.

FIG. 17 schematically shows a measuring device 1000 according to further embodiments. The measuring device 1000 has a measuring head 1002 in which at least one apparatus 100i according to the embodiments is arranged in order to apply terahertz radiation TS on a measurement object OBJ″ (e.g. a body part) and to receive terahertz radiation TSR reflected from or at the measurement object OBJ″, which can in particular contain information about the layer structure of the measurement object OBJ″, in particular paint layer thicknesses. Optionally, measuring device 1000 comprises a positioning system 1004, which may be, for example, a robot, in particular an industrial robot. According to further embodiments, measuring device 1000 can be efficiently used in manufacturing facilities and/or production lines to perform measurements based on THz radiation in a precise and efficient manner.

1-44. (canceled)

45. Apparatus for transmitting and/or receiving terahertz (THz) radiation, comprising:
at least one terahertz element configured to generate and/or detect a THz signal;
at least one field-shaping element, wherein the at least one terahertz element is arranged in a region of a first surface of the field-shaping element, wherein the at least one terahertz element is arranged relative to the first surface of the field-shaping element such that, at least regionally, an evanescent coupling exists between the at least one terahertz element and the field-shaping element; and
wherein the at least one terahertz element comprises a first substrate and an electrode arrangement, wherein the electrode arrangement is arranged on a first surface of the first substrate of the at least one terahertz element, and wherein the first surface of the first substrate of the at least one terahertz element is facing the first surface of the field shaping element.

46. The apparatus according to claim 45, wherein the field-shaping element has, in the region of at least one surface, a surface modification with a reflection-reducing effect, wherein the reflection-reducing effect is optimized for a frequency range between 4.5 THz and 6.5 THz.

47. The apparatus according to claim 46, wherein, at least regionally, a bonding layer is arranged between the at least one terahertz element and the first surface of the field-shaping element, wherein the layer thickness of the bonding layer is smaller than a quarter of a wavelength of the THz signal in the bonding layer, or smaller than a quarter of a wavelength of a maximum frequency of the THz signal in the bonding layer.

48. The apparatus according to claim 47, wherein the bonding layer at least partially comprises at least one of the following materials or is formed from at least one of the following materials: a) polymeric material; b) polymeric material with at least one additive material which is a refractive index-increasing additive material; or c) adhesive material.

49. The apparatus according to claim 48, wherein the bonding layer has a refractive index n greater than or equal to 1.6.

50. The apparatus according to claim 45, wherein the at least one terahertz element and/or the first substrate of the at last one terahertz element comprises a photoconductive material, wherein the photoconductive material comprises at least one of the following materials: (a) indium phosphide (InP); (b) gallium arsenide (GaAs); or (c) indium gallium arsenide (InGaAs).

51. The apparatus according to claim 50, wherein the at least one terahertz element comprises at least one further substrate, and wherein the first substrate is arranged, at least regionally, on the at least one further substrate.

52. The apparatus according claim 51, wherein the first substrate and/or at least one further substrate or the at least one further substrate is at least partially transparent to optical radiation in a wavelength range between 1450 nanometers (nm) to 1650 nm and/or in a wavelength range between 850 nm and 1650 nm.

53. The apparatus according to claim 52, wherein the at least one further substrate comprises a material different from the material of the first substrate.

54. The apparatus according to claim 53, wherein a) a second surface opposite the first surface of the first substrate of the at least one terahertz element, and/or b) the second surface opposite the first surface of the first substrate of the at least one terahertz element, and/or c) a second surface opposite a first surface of the at least one further substrate is exposed to a first optical radiation, in particular to laser radiation, in particular to laser radiation in a wavelength range between 1450 nm and 1650 nm.

55. The apparatus according to claim 54, wherein an irradiation device is provided for at least temporarily exposing at least one region of the at least one terahertz element to a first optical radiation, wherein the irradiation device comprises at least one optical fiber or is formed as an optical fiber.

56. The apparatus according to claim 55, wherein the optical fiber is a polarisation maintaining fiber.

57. The apparatus according to claim 45, wherein the apparatus comprises a plurality of terahertz elements, wherein a) at least two of the plurality of terahertz elements are arranged in the region of the first surface of the field-shaping element, and/or b) the at least one field-shaping element is assigned to at least two of the plurality of terahertz elements.

58. The apparatus according to claim 57, wherein a) at least two of the plurality of terahertz elements at least partially overlap spatially, and/or wherein b) a common electrode structure is assigned to the plurality of terahertz elements.

59. The apparatus according to claim 58, wherein the apparatus is adapted to output and/or receive the terahertz radiation in the form of a collimated beam.

60. The apparatus according to claim 45, wherein the apparatus is adapted to at least temporarily apply to the at least one terahertz element a first pulsed laser radiation having a first pulse frequency and a second pulsed laser radiation having a second pulse frequency, wherein the second pulse frequency is at least temporarily different from the first pulse frequency.

61. The apparatus according to claim 60, wherein the apparatus comprises a first laser source for generating and/or providing the first laser radiation and a second laser source for generating and/or providing the second laser radiation.

62. The apparatus according to claim 60, wherein the apparatus is adapted to provide a protective gas flow comprising a protective gas in at least one region of a beam path of the THz radiation.

63. The apparatus according to claim 45, wherein the apparatus comprises at least one optical sensor device capable of detecting or determining at least one of the following: a) a distance of a measurement object relative to the apparatus; b) an inclination of the apparatus relative to the measurement object; or c) a surface shape of the measurement object.

64. A measuring device for determining a layer thickness of one or more layers of an object, comprising:
at least one terahertz element configured to generate and/or detect a THz signal;
at least one field-shaping element, wherein the at least one terahertz element is arranged in a region of a first surface of the field-shaping element, wherein the at least one terahertz element is arranged relative to the first surface of the field-shaping element such that, at least regionally, an evanescent coupling exists between the at least one terahertz element and the field-shaping element; and
wherein the at least one terahertz element comprises a first substrate and an electrode arrangement, wherein the electrode arrangement is arranged on a first surface of the first substrate of the at least one terahertz element, and wherein the first surface of the first substrate of the at least one terahertz element is facing the first surface of the field shaping element; and
at least one optical sensor device for detecting or determining at least one of the following: a) a distance of a measurement object relative to the apparatus; b) an inclination of the apparatus relative to the measurement object; or c) a surface shape of the measurement object.

65. The measuring device of claim 64, wherein the field-shaping element comprises:
a surface modification to the region of the first surface of the field-shaping element, wherein the surface modification wherein the surface modification provides a reflection-reducing effect, wherein the reflection-reducing effect is optimized for a frequency range between 4.5 THz and 6.5 THz.

66. The measuring device according to claim 64 wherein the measuring device comprises a plurality of terahertz elements, wherein a) at least two of the plurality of terahertz elements are arranged in the region of the first surface of the field-shaping element, and/or b) the at least one field-shaping element is assigned to at least two of the plurality of terahertz elements.

67. The measuring device according to claim 64 wherein wherein a) at least two of the plurality of terahertz elements at least partially overlap spatially, and/or wherein b) a common electrode structure is assigned to the plurality of terahertz elements.

68. The measuring device according to claim 64, wherein the measuring device is adapted to at least temporarily apply to the at least one terahertz element a first pulsed laser radiation having a first pulse frequency and a second pulsed laser radiation having a second pulse frequency, wherein the second pulse frequency is at least temporarily different from the first pulse frequency.

69. The measuring device according to claim 64, wherein the measuring device comprises a first laser source for generating and/or providing the first laser radiation and a second laser source for generating and/or providing the second laser radiation.

70. A method for determining a layer-thickness of one or more layers of an object, comprising:
at least one terahertz element configured to generate and/or detect a THz signal;
at least one field-shaping element, wherein the at least one terahertz element is arranged in a region of a first surface of the field-shaping element, wherein the at least one terahertz element is arranged relative to the first surface of the field-shaping element such that, at least regionally, an evanescent coupling exists between the at least one terahertz element and the field-shaping element; and
wherein the at least one terahertz element comprises a first substrate and an electrode arrangement, wherein the electrode arrangement is arranged on a first surface of the first substrate of the at least one terahertz element, and wherein the first surface of the first substrate of the at least one terahertz element is facing the first surface of the field shaping element; and
at least one optical sensor device for detecting or determining at least one of the following: a) a distance of a measurement object relative to the apparatus; b) an inclination of the apparatus relative to the measurement object; or c) a surface shape of the measurement object,
at least temporarily positioning a first mirror and at least temporarily positioning a second mirror in the beam path of the THz radiation for directing the THz radiation onto the measurement object.

71. The method for measuring of claim 70, further comprising:
at least temporarily applying to at least one space region a protective gas; and
transmitting the THz radiation into the at least one space region to which the protective gas is applied.
